(19) United States
(12) Patent Application Publication
(10) Pub. No.: US 2020/0140280 A1
(43) Pub. Date: May 7, 2020

(54) PURIFICATION SYSTEMS AND METHODS FOR CARBON DIOXIDE PRODUCTION

(71) Applicant: SABIC Global Technologies B.V., Bergen op Zoom (NL)

(72) Inventors: Yousef AL-HAWSAWI, Madinat Al-Jubail (SA); Muhammad Farooq FAREED, Madinat Al-Jubail (SA)

(21) Appl. No.: 16/621,311

(22) PCT Filed: Apr. 5, 2018
(86) PCT No.: PCT/IB2018/052381

§ 371 Date: Dec. 11, 2019

Related U.S. Application Data
(60) Provisional application No. 62/518,831, filed on Jun. 13, 2017.

(51) Int. Cl. C01B 32/50; B01D 53/70; B01D 53/34; B01D 53/76; B01D 53/86; B01J 23/44; B01J 21/04

(52) U.S. Cl. CPC C01B 32/50; C01B 2210/0004; B01D 53/346; B01D 53/76; B01D 53/8662; B01D 53/8696; B01J 23/44; B01J 21/04; B01D 2251/102; B01D 2251/208; B01D 2256/22; B01D 2257/2064; B01D 2255/1023; B01D 2255/2092; C01B 2210/0068; B01D 53/70

(57) ABSTRACT

Systems and methods for purifying a carbon dioxide gas mixture are disclosed. A carbon dioxide purification and in liquefaction unit integrated with an external hydrocarbon dosing system is used to purify a mixture that includes (1) primarily carbon dioxide and (2) other material including an organic chloride and other organic hydrocarbons. The organic chloride in the mixture may be substantially removed via controlling the amount of the organic chloride reacted in the reactor of the carbon dioxide purification and liquefaction unit. The controlling of the organic chloride content is executed by the external hydrocarbon dosing system. The external hydrocarbon dosing system is configured to maintain a temperature of the effluent from the reactor within a predetermined range via controlling the flow rate of the external hydrocarbon into the mixture.

### CROSS REFERENCE TO RELATED APPLICATIONS

This application claims the benefit of priority of U.S. Provisional Patent Application No. 62/518,831, filed Jun. 13, 2017, which is hereby incorporated by reference in its entirety.

### FIELD OF INVENTION

The present invention generally relates to chemical purification technologies. More specifically, the present invention relates to systems and methods that purify carbon dioxide generated from chemical production facilities.

### BACKGROUND OF THE INVENTION

Carbon dioxide is used in a wide variety of industries such as oil and gas (e.g. enhanced oil recovery), beverage (e.g. carbonation), food, and chemical (e.g. calcium carbonate production). Currently, a large portion of carbon dioxide supply in the market comes from byproduct streams of various chemical production processes, including ammonia production, ethanol production, ethylene glycol production, and natural gas processing.

However, these byproduct streams that contain primarily carbon dioxide often include various organic impurities, for instance, organic chlorides and/or hydrocarbons. Thus, to ensure the quality of carbon dioxide supply for subsequent processes and/or further applications, a carbon dioxide purification and liquefaction unit is typically used to convert these impurities into more carbon dioxide and/or other compounds, such as water and inorganic chlorides, which can be easily removed or recovered.

In a conventional carbon dioxide purification and liquefaction unit, the hydrocarbons from the byproduct streams are generally combusted to generate heat, carbon dioxide and water. Other impurities in the carbon dioxide mixture, such as organic chlorides, may be converted into hydrogen chloride via an endothermic process. Depending on the compositions of the byproduct streams flowing into the carbon dioxide purification and liquefaction unit, compounds such as organic chlorides are often not fully converted due to high organic chloride concentration in the mixture and/or insufficient reaction conditions for full conversion of the organic chloride. The carbon dioxide product resulting from such a process may be low grade or even hazardous to human health. Therefore, improvements in the carbon dioxide purification and liquefaction process are desired.

### BRIEF SUMMARY OF THE INVENTION

A method has been discovered for purifying a mixture comprising (1) primarily carbon dioxide and (2) other material that includes organic chlorides and other organic compounds. By controlling the amount of the organic chlorides reacted in the reactor of a carbon dioxide purification and liquefaction unit using an external hydrocarbon dosing system, the organic chloride residual in the carbon dioxide can be minimized.

Embodiments of the invention include a method of purifying a mixture that comprise (1) primarily carbon dioxide and (2) other material that includes organic chloride. The method may include flowing the mixture to a reactor. Oxygen may also be flowed to the reactor. The method may further include reacting at least some of the organic chloride with the oxygen to form additional carbon dioxide. The method may further include flowing an effluent from the reactor. The method may further still include controlling the amount of organic chloride reacted in the reactor by maintaining a reaction temperature in the reactor within a predetermined range. The controlling may comprise measuring the effluent's temperature, and if the measured temperature of the effluent is below a predetermined minimum temperature, injecting, or increasing a rate of injecting, hydrocarbon into the mixture.

Embodiments of the invention include a method of purifying a mixture from an ethylene glycol plant that comprises (1) primarily carbon dioxide and (2) other material that includes organic chlorides. The method may include flowing the mixture to a reactor and flowing oxygen to the reactor. The method may further include reacting at least some of the organic chloride with the oxygen to form additional carbon dioxide. The method may further include flowing an effluent from the reactor. The method may further still include controlling the amount of organic chloride reacted in the reactor by maintaining reaction temperature in the reactor within a predetermined range. The controlling may comprise measuring the effluent's temperature, and if the measured temperature of the effluent is below a predetermined minimum temperature, injecting, or increasing a rate of injecting, hydrocarbon into the mixture.

Embodiments of the invention include a method of purifying a mixture from an ethylene glycol plant that may comprise (1) primarily carbon dioxide and (2) other material that includes organic chloride. The method may include flowing the mixture to a reactor. Oxygen may also be flowed to the reactor. The method may further include reacting at least some of the organic chloride with the oxygen to form additional carbon dioxide. The method may further include flowing an effluent from the reactor. The method may further include automatically controlling the amount of organic chloride reacted in the reactor by maintaining reaction temperature in the reactor within a predetermined range. The controlling may comprise automatically injecting external hydrocarbon that may include ethylene, methane and/or other fuel gas, into the mixture. The injecting may comprise automatically measuring the effluent's temperature. If the measured temperature of the effluent is below a predetermined minimum temperature, automatically activating a control valve to allow flow of, or increase a rate of flow of the external hydrocarbon into the mixture. If the measured temperature of the effluent is above a predetermined maximum temperature, automatically activating the control valve to stop flow of, or reduce flow of, the external hydrocarbon into the mixture.

The following includes definitions of various terms and phrases used throughout this specification.

The terms “about” or “approximately” are defined as being close to as understood by one of ordinary skill in the art. In one non-limiting embodiment the terms are defined to be within 10%, preferably, within 5%, more preferably, within 1%, and most preferably, within 0.5%.

The terms “wt. %”, “vol. %” or “mol. %” refers to a weight, volume, or molar percentage of a component, respectively, based on the total weight, the total volume, or the total moles of material that includes the component. In a non-limiting example, 10 moles of component in 100 moles of the material is 10 mol. % of component.

The term “substantially” and its variations are defined to include ranges within 10%, within 5%, within 1%, or within 0.5%.

The terms “inhibiting” or “reducing” or “preventing” or “avoiding” or any variation of these terms, when used in the claims and/or the specification, includes any measurable decrease or complete inhibition to achieve a desired result.

The term “effective,” as that term is used in the specification and/or claims, means adequate to accomplish a desired, expected, or intended result.

The term “automatic” or “automatically” as that term is used in the specification and/or claims means executing mechanisms of operation or regulation without continuous direct human intervention.

The term “external hydrocarbon”, as that term is used in the specification and/or claims means hydrocarbon or hydrocarbons that are not included in the mixture being purified, e.g. the mixture comprising (1) primarily carbon oxide and (2) other material.

The use of the words “a” or “an” when used in conjunction with the term “comprising,” “including,” “containing,” or “having” in the claims or the specification may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The process of the present invention can “comprise,” “consist essentially of,” or “consist of” particular ingredients, components, compositions, etc., disclosed throughout the specification.

In the context of the present invention, nineteen embodiments are now described. Embodiment 1 is a method of purifying a mixture that contains (1) primarily carbon dioxide (CO₂) and (2) other material, wherein the other material includes an organic chloride. The method includes the steps of flowing the mixture to a reactor; flowing oxygen (O₂) to the reactor; reacting at least some of the organic chloride with the O₂ to form additional CO₂; flowing an effluent from the reactor; controlling the amount of the organic chloride reacted in the reactor by maintaining reaction temperature in the reactor within a predetermined range, wherein the controlling includes the steps of measuring the effluent's temperature; and if the measured temperature of the effluent is below a predetermined minimum temperature, injecting, or increasing a rate of injecting, an external hydrocarbon into the mixture. Embodiment 2 is the method of embodiment 1, wherein the controlling further includes: if the measured temperature of the effluent is above a predetermined maximum temperature, automatically activating a control valve to stop flow of, or reduce flow of, the external hydrocarbon into the mixture. Embodiment 3 is the method of any of embodiments 1 or 2, wherein the mixture is from an ethylene glycol plant. Embodiment 4 is the method of any of embodiments 1 to 3, wherein the other material further include compounds selected from the group consisting of methane, ethylene, ethylene oxide, and combinations thereof. Embodiment 5 is the method of any of embodiments 1 to 4, wherein the organic chloride is selected from the group consisting of ethylene dichloride, ethylene chloride, vinyl chloride, methyl chloride, acetyl chloride, and combinations thereof. Embodiment 6 is the method of any of embodiments 1 to 5, wherein the external hydrocarbon contains fuel gas, the fuel gas is selected from the group consisting of ethylene, methane, ethane, and combinations thereof. Embodiment 7 is the method of any of embodiments 1 to 6, wherein the flowing the mixture to a reactor includes the steps of flowing the mixture to a feed compressor to form a feed stream; flowing the feed stream from the feed compressor through one or more heat exchangers to heat the feed stream; and flowing the heated feed stream to the reactor. Embodiment 8 is the method of embodiment 7, wherein the feed compressor is a two-stage compressor. Embodiment 9 is the method of any of embodiments 7 and 8, wherein the flowing the oxygen to the reactor includes the steps of flowing the oxygen to the feed compressor such that the oxygen mixes with the feed stream; flowing the oxygen mixed with the feed stream through one or more heat exchangers to heat the oxygen and the feed stream; and flowing the heated oxygen and the heated feed stream to the reactor. Embodiment 10 is the method of embodiment 9, wherein the oxygen is flowed to the compressor on a second stage of the compressor. Embodiment 11 is the method of any of embodiments 9 and 10, wherein the oxygen and the feed stream are heated by the one or more heat exchangers to a temperature in a range of 280° C. to 420° C. Embodiment 12 is the method of any of embodiments 1 to 11, wherein the reacting is performed in the reactor at an operating pressure of 15 to 20 barg. Embodiment 13 is the method of any of embodiments 1 to 12, wherein the reacting is performed in the presence of a catalyst selected from the group consisting of Pd, Al₂O₃, and combinations thereof. Embodiment 14 is the method of any of embodiments 1 to 13, wherein the effluent contains compounds selected from the group consisting of carbon dioxide, water, inorganic chloride, methane, ethylene, oxygen, nitrogen, argon, ethylene oxide, and combinations thereof. Embodiment 15 is the method of any of embodiments 1 to 14, further including measuring an amount of organic chloride in the effluent. Embodiment 16 is the method of any of embodiments 1 to 15, wherein an organic chloride content in the effluent is below 5 ppmv. Embodiment 17 is the method of any of embodiments 1 to 16, wherein the predetermined minimum reaction temperature in the controlling step is 280° C. and the predetermined maximum reaction temperature in the controlling step is 420° C. Embodiment 18 is the method of any of embodiments 1 to 17, wherein a maximum amount of external hydrocarbon injected in the mixture is 2000 ppmv.

Embodiment 19 is a method of purifying a mixture from an ethylene glycol plant that comprises (CO₂) and (2) other material, wherein the other material includes an organic chloride. This method includes the steps of flowing the mixture to a reactor; flowing oxygen (O₂) to the reactor; reacting at least some of the organic chloride with the O₂ to form additional CO₂; flowing an effluent from the reactor; automatically controlling the amount of the organic chloride reacted in the reactor by maintaining reaction temperature in the reactor within a predetermined range, the controlling including the steps of: automatically injecting an external hydrocarbon comprising methane, ethylene and other fuel gas into the mixture, wherein the automatically injecting includes the steps of: automatically measuring the effluent's temperature; if the measured temperature of the effluent is below a predetermined minimum temperature, automatically activating a control valve to allow flow of, or increase a rate of flow of, the external hydrocarbon into the mixture; and if the measured temperature of the effluent is above a predetermined maximum temperature, automatically activating the control valve to stop flow of, or reduce flow of, the external hydrocarbon into the mixture.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

For a more complete understanding, reference is now made to the following descriptions taken in conjunction with the accompanying drawings, in which:

FIG. 1 shows a schematic diagram of a carbon dioxide purification and liquefaction unit integrated with an external hydrocarbon dosing system, according to embodiments of the invention; and

FIG. 2 shows a schematic flowchart of a method of purifying a carbon dioxide mixture using a carbon dioxide purification and liquefaction unit, according to embodiments of the invention.

### DETAILED DESCRIPTION OF THE INVENTION

A method has been discovered for purifying a mixture comprising primarily carbon dioxide (CO₂) mixed with impurities such as organic chlorides. The mixture may be a feed stream from an ethylene glycol plant that is sent to a carbon dioxide purification and liquefaction unit. By using a temperature controlled external hydrocarbons dosing system to add hydrocarbons in the feed stream, the amount of organic chlorides reacted in the reactor may be controlled accordingly. The temperature in the reactor of the carbon dioxide purification and liquefaction unit can be maintained at a level sufficient to convert substantially all the impurities including organic chloride, thereby remedying the issue of unconverted impurities in the product stream of carbon dioxide from a conventional carbon dioxide purification and liquefaction unit.

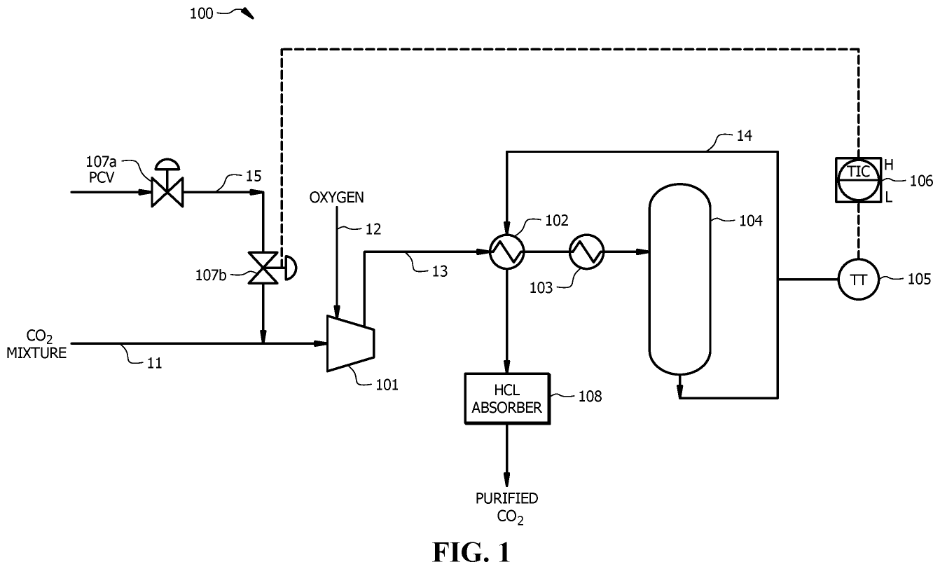

With reference to FIG. 1, a schematic diagram is shown of carbon dioxide purification and liquefaction unit 100 for removing impurities from a mixture. As shown in FIG. 1, the mixture may form stream 11 and flow into feed compressor 101 of carbon dioxide purification and liquefaction unit 100. In embodiments of the invention, the mixture may be from a chemical production plant, such as an ethylene glycol production plant. The mixture from the ethylene glycol production plant may include (1) primarily carbon dioxide and (2) impurities that may include 3 ppmv to 7 ppmv (e.g. 5 ppmv) of organic chloride, 45 ppmv to 55 ppmv (e.g. 50 ppmv) of methane, 1500 ppmv to 2500 ppmv (e.g. 2000 ppmv) of ethylene, 12 to 20 ppmv (e.g. 16 ppmv) of ethylene oxide, and 15 ppmv to 25 ppmv (e.g. 20 ppmv) of other hydrocarbons or combinations thereof. According to embodiments of the invention, feed compressor 101 may be configured to compress stream 11 to a pressure of 14 barg to 21 barg and all ranges and values therebetween. In embodiments of the invention, feed compressor 101 may comprise an inlet for adding oxygen. In embodiments of the invention, feed compressor 101 may be a two-stage compressor. Oxygen of stream 12 may be added to the carbon dioxide mixture on the second stage of the compressing process of feed compressor 101. The mixture of stream 11 and the oxygen of stream 12 may be compressed to form stream 13.

According to embodiments of the invention, carbon dioxide purification and liquefaction unit 100 may further include first heat exchanger 102 in fluid communication with an outlet of feed compressor 101. First heat exchanger 102 may be configured to heat stream 13. In embodiments of the invention, carbon dioxide purification and liquefaction unit 100 may further include second heat exchanger 103 in fluid communication with an outlet of first heat exchanger 102. Second heat exchanger 103 may be configured to further heat stream 13. According to embodiments of the invention, heated stream 13 exiting first heat exchanger 102 and/or second heat exchanger may be at a temperature in a range of 285° C. to 420° C. and all ranges and values therebetween, including ranges of 285° C. to 300° C., 300° C. to 310° C., 310° C. to 320° C., 320° C. to 330° C., 330° C. to 340° C., 340° C. to 350° C., 350° C. to 360° C., 360° C. to 370° C., 370° C. to 380° C., 380° C. to 390° C., 390° C. to 400° C., 400° C. to 410° C., or 410° C. to 420° C.

In embodiments of the invention, carbon dioxide purification and liquefaction unit 100 may further comprise reactor 104 in fluid communication with an outlet of second heat exchanger 103. Reactor 104 may be configured to convert hydrocarbons and/or the organic chloride from the mixture into carbon dioxide, water and/or inorganic chloride such as hydrogen chloride. In embodiments of the invention, reactor 104 may comprise a pre-startup electric heater to heat stream 13 to a combustion temperature at the initiation stage of the combustion. In embodiments of the invention, the combustion temperature may be in a range of 280° C. to 420° C. and all ranges and values therebetween.

According to embodiments of the invention, reactor 104 may include a catalyst for converting an organic chloride an into inorganic chloride. Exemplary catalysts may include, but are not limited to Pd, Al₂O₃ or combinations thereof. In embodiments of the invention, reactor 104 may be designed for a reaction temperature in a range of 280° C. to 530° C. and all ranges and values therebetween including ranges of 280° C. to 290° C., 290° C. to 300° C., 300° C. to 310° C., 310° C. to 320° C., 320° C. to 330° C., 330° C. to 340° C., 340° C. to 350° C., 350° C. to 360° C., 360° C. to 370° C., 370° C. to 380° C., 380° C. to 390° C., 390° C. to 400° C., 400° C. to 410° C., 410° C. to 420° C., 420° C. to 430° C., 430° C. to 440° C., 440° C. to 450° C., 450° C. to 460° C., 460° C. to 470° C., 470° C. to 480° C., 480° C. to 490° C., 490° C. to 500° C., 500° C. to 510° C., 510° C. to 520° C., or 520° C. to 530° C.

According to embodiments of the invention, if a temperature in reactor 104 is above the upper limit of the temperature range, the catalyst and/or the reactor may be damaged. On the other hand, if a temperature in reactor 104 is below the lower limit of the temperature range, organic chloride in the mixture may not be fully converted, resulting in chloride impurity in the final carbon dioxide product. In embodiments of the invention, reactor 104 may have an operating pressure of 15 to 20 barg, and all ranges and values therebetween including 15 barg, 16 barg, 17 barg, 18 barg, 19 barg, or 20 barg.

In embodiments of the invention, an outlet of reactor 104 may be in fluid communication with an inlet of first heat exchanger 102. In this way, first heat exchanger 102 is configured to heat up stream 13 by heat from product stream 14 flowing from reactor 104, thereby cooling product stream 14. According to embodiments of the invention, temperature transmitter 105 may be configured to measure temperatures of product stream 14. A product compressor may be used to compress product stream 14. In embodiments of the invention, carbon dioxide purification and liquefaction unit 100 may further include an external hydrocarbon dosing system in electrical communication with temperature transmitter 105.

According to embodiments of the invention, the hydrocarbon dosing system may include temperature controller 106 and one or more valves 107a and/or 107b in electrical communication with temperature controller 106. In embodiments of the invention, one or more valves 107a and/or 107b may be configured to control a flowrate of an external hydrocarbon of stream 15 flowing to stream 11. Additionally or alternatively, the external hydrocarbon of stream 15 may be flowed directly to reactor 104. In embodiments of the invention, the flowrate of the hydrocarbon may be controlled by temperature controller 106.

In embodiments of the invention, the flowrate of an external hydrocarbon that is dosed in reactor 104 via the hydrocarbon dosing system may increase if a temperature measurement of temperature transmitter 105 is lower than a lower limit of a pre-determined temperature range. Increased flowrate of the external hydrocarbon, according to embodiments of the invention, results in an increased amount of external hydrocarbon combusting in reactor 104, thereby raising the temperature in reactor 104 and the temperature of product stream 14. Subsequently, more organic chloride of stream 11 may be reacted in reactor 104 via an endothermic reaction. According to embodiments of the invention, the flowrate of the hydrocarbon may be reduced when a temperature reading of temperature transmitter 105 is higher than a higher limit of the pre-determined temperature range. Decreased external hydrocarbon flowrate in reactor 104 may result in a lower temperature in reactor 104 and less organic chloride reacted in reactor 104. In embodiments of the invention, the pre-determined temperature range may be 280° C. to 530° C. and all ranges and values therebetween including ranges of 280° C. to 290° C., 290° C. to 300° C., 300° C. to 310° C., 310° C. to 320° C., 320° C. to 330° C., 330° C. to 340° C., 340° C. to 350° C., 350° C. to 360° C., 360° C. to 370° C., 370° C. to 380° C., 380° C. to 390° C., 390° C. to 400° C., 400° C. to 410° C., 410° C. to 420° C., 420° C. to 430° C., 430° C. to 440° C., 440° C. to 450° C., 450° C. to 460° C., 460° C. to 470° C., 470° C. to 480° C., 480° C. to 490° C., 490° C. to 500° C., 500° C. to 510° C., 510° C. to 520° C., or 520° C. to 530° C.

Additionally or alternatively, according to embodiments of the invention, the hydrocarbon dosing system may comprise an organic chloride detecting device configured to measure a concentration of organic chloride in product stream 14. In embodiments of the invention, the hydrocarbon dosing system may comprise a concentration control device in electrical communication with one or more valves 107a and/or 107b and the organic chloride detecting device. In embodiments of the invention, the concentration control device may increase the flowrate of the external hydrocarbon by controlling one or more valves 107a and/or 107b such that more organic chloride may react in reactor 104 when a concentration reading of the organic chloride detecting device is higher than a higher limit of a pre-determined concentration range of the organic chloride. In embodiments of the invention, the concentration control device may reduce the flowrate of the hydrocarbon by controlling one or more valves 107a and/or 107b.

In embodiments of the invention, valve 107a is configured to provide a smooth pressure to downstream (as per requirement and to avoid any back pressure). Valve 107b can be manipulated with respect to reactor temperature (valve opening is inversely proportional to reactor temperature). Valve 107b can also have a solenoid to work as XV in case of high temperature in reactor and/or when the compressor is down. In embodiments of the invention, the temperature controller may be a temperature indicating controller. According to embodiments of the invention, one or more valves 107a and/or 107b may include self-actuating pressure control valves. The self-actuating pressure control valve may be a thermal circulation valve and/or a positive crankcase ventilation valve. The external hydrocarbon may comprise ethylene, methane, ethane, other fuel gas, or combinations thereof.

According to embodiments of the invention, carbon dioxide purification and liquefaction unit 100 may further include a first shutdown switch configured to close feed compressor 101 and/or valves 107a and 107b when the temperature measurement of temperature transmitter 105 is higher than a system shutdown high temperature. The system shutdown high temperature may be 525° C. to 535° C. (e.g. 530° C.). In embodiments of the invention, carbon dioxide purification and liquefaction unit 100 may further include a second shutdown switch configured to close the product compressor when the temperature measurement of temperature transmitter 105 is lower than a system shutdown low temperature. According to embodiments of the invention, the system shutdown low temperature may be 275° C. to 285° C. (e.g. 280° C.).

According to embodiments of the invention, carbon dioxide purification and liquefaction unit 100 may further include hydrogen chloride (HCl) absorber 108 configured to absorb hydrogen chloride from product stream 14. In embodiments of the invention, the hydrocarbon dosing system in carbon dioxide purification and liquefaction unit 100 overall may be configured to control the amount of the organic chlorides reacted in reactor 104 by controlling the external hydrocarbon flowed into reactor 104.

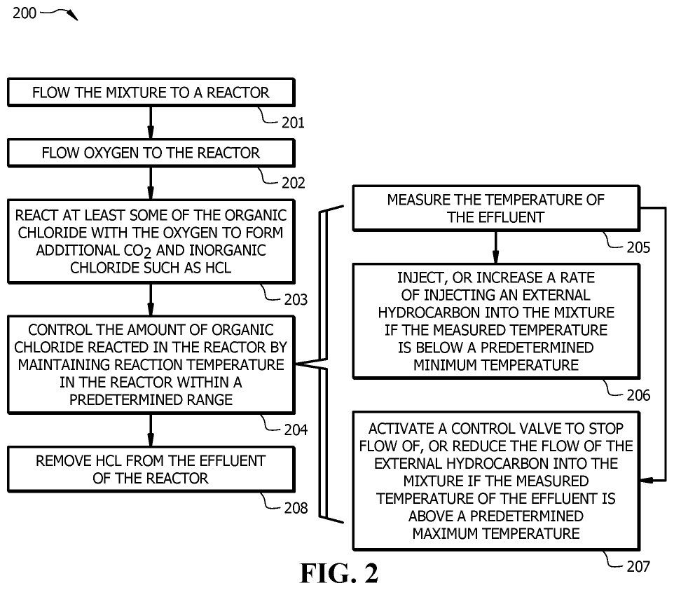

As shown in FIG. 2, embodiments of the invention include method 200 of purifying a mixture that comprises (1) primarily carbon dioxide (CO₂) and (2) other material. Method 200 may be performed in carbon dioxide purification and liquefaction unit 100. As described above, in embodiments of the invention, the mixture may be from a chemical production plant, such as an ethylene glycol production plant. The mixture from the ethylene glycol production plant may comprise (1) primarily carbon dioxide and (2) impurities that may comprise organic chlorides, methane, ethylene, ethylene oxide and/or other hydrocarbons. According to embodiments of the invention, the organic chlorides may comprise ethylene dichloride, ethylene chloride, vinyl chloride, methyl chloride, acetyl chloride, or combinations thereof.

As shown in block 201, the mixture may be flowed to reactor 104. Block 202 shows that oxygen may be flowed in to reactor 104. In embodiments of the invention, oxygen of stream 12 may be flowed into feed compressor 101. The mixture of stream 11 and oxygen of stream 12 may be compressed in feed compressor 101 and form stream 13. According to embodiments of the invention, feed compressor 101 may be a two-stage or four-stage compressor. Oxygen in stream 12 may be flowed to the second stage of feed compressor 101. In embodiments of the invention, stream 13 comprising the mixture of stream 11 and the oxygen of stream 12 may be heated by first heat exchanger 102 and/or second heat exchanger 103. Heated stream 13 may be at a temperature in a range of 130° C. to 140° C. (e.g. 135° C.) and all ranges and values therebetween including. Alternatively or additionally, oxygen of stream 12 may not mix with the mixture before the oxygen enters reactor 104. Therefore, the oxygen may be directly flowed into reactor 104.

As shown in block 203, method 200 may further include reacting at least some of the organic chlorides with the oxygen to form additional CO₂ in reactor 104. According to embodiments of the invention, the reaction of the organic chloride with the oxygen in reactor 104 may further form an inorganic chloride. In embodiments of the invention, exemplary inorganic chlorides may include hydrogen chloride.

In embodiments of the invention, the reacting may be performed under reaction conditions sufficient to convert the organic chloride into inorganic chloride. The reaction conditions may comprise an operating pressure of 15 to 20 barg and all ranges and values therebetween including 15 barg, 16 barg, 17 barg, 18 barg, 19 barg, or 20 barg. The reaction conditions may further comprise a reaction temperature in a range of 280° C. to 530° C. and all ranges and values therebetween including ranges of 280° C. to 290° C., 290° C. to 300° C., 300° C. to 310° C., 310° C. to 320° C., 320° C. to 330° C., 330° C. to 340° C., 340° C. to 350° C., 350° C. to 360° C., 360° C. to 370° C., 370° C. to 380° C., 380° C. to 390° C., 390° C. to 400° C., 400° C. to 410° C., 410° C. to 420° C., 420° C. to 430° C., 430° C. to 440° C., 440° C. to 450° C., 450° C. to 460° C., 460° C. to 470° C., 470° C. to 480° C., 480° C. to 490° C., 490° C. to 500° C., 500° C. to 510° C., 510° C. to 520° C., or 520° C. to 530° C. According to embodiments of the invention, the reaction conditions may further include the presence of a catalyst selected from the group consisting of Pd, Al₂O₃, or combinations thereof.

In embodiments of the invention, method 200 may include flowing an effluent from reactor 104. According to embodiments of the invention, an effluent may form product stream 14. The effluent of product stream 14 from reactor 104 may comprise carbon dioxide, water, inorganic chloride, methane, ethylene, oxygen, nitrogen, argon, ethylene oxide, or combinations thereof. In embodiments of invention, extremely low amount of hydrogen chloride slippage may be in product stream 14 from reactor 104. Ethylene oxide may be in up to part per billion level in stream 14 from reaction 104. In embodiments of the invention, the effluent from reactor 104 may pass through first heat exchanger 102 and cooled by the mixture and oxygen of stream 13.

In embodiments of the invention, as shown in block 204, method 200 may further include controlling the amount of organic chloride reacted in reactor 104 by maintaining reaction temperature in reactor 104 within a predetermined range. According to embodiments of the invention, the predetermined temperature range may be 280° C. to 420° C. and all ranges and values therebetween including ranges of 280° C. to 290° C., 290° C. to 300° C., 300° C. to 310° C., 310° C. to 320° C., 320° C. to 330° C., 330° C. to 340° C., 340° C. to 350° C., 350° C. to 360° C., 360° C. to 370° C., 370° C. to 380° C., 380° C. to 390° C., 390° C. to 400° C., 400° C. to 410° C., or 410° C. to 420° C. In embodiments of the invention, the controlling may comprises automatically injecting an external hydrocarbon into the mixture.

According to embodiments of the invention, the controlling in block 204 may comprise automatically measuring the temperature of the effluent from reactor 104 via temperature transmitter 105, as shown in block 205. In embodiments of the invention, the controlling may be conducted via temperature controller 106. As shown in block 206, the controlling in block 204 may further comprise injecting or increasing a rate of injecting external hydrocarbon into the mixture of stream 11, if the measured temperature of the effluent is below a predetermined minimum temperature. In embodiments of the invention, the predetermined minimum temperature may be 270° C. to 290° C. (e.g. 280° C.). The injecting or increasing a rate of injecting external hydrocarbon may include a step of activating a control valve to allow flow of, or increase a rate of flow of the external hydrocarbon. In embodiments of the invention, the control valve may include a thermal circulation valve.

In embodiments of the invention, the controlling in block 204 may further include stopping flow of, or reducing flow of the external hydrocarbon into the mixture if the measured temperature of the effluent is above a predetermined maximum temperature, as shown in block 207. According to embodiments of the invention, the predetermined maximum temperature may be 520° C. to 540° C. (e.g. 530° C.). The stopping the flow of, or reducing the flow of, the external hydrocarbon may include activating the control valve to stop flow of, or reduce the flow of, the external hydrocarbon. According to embodiments of the invention, the external hydrocarbon may include fuel gas, ethylene, and/or methane. The fuel gas may be selected from the group consisting of methane, ethylene, ethane, and combinations thereof.

In embodiments of the invention, the maximum amount of external hydrocarbon injected in the mixture in blocks 205 and 206 may be 2000 ppmv over the mixture of stream 11. The external hydrocarbon may be fully combusted in reactor 104 to form water and carbon dioxide. According to embodiments of the invention, an amount of the organic chloride in the effluent from reactor 104 may be measured. In embodiments of the invention, the organic chloride content in the effluent is below 50 ppbv. As an alternative to or in addition to temperature measurements, measurements of the organic chloride content in the effluent may be used to control the flow rate of external hydrocarbon in the controlling of block 204.

According to embodiments of the invention, block 208 shows that method 200 may further include removing hydrogen chloride in the effluent via hydrogen chloride absorber 108. Furthermore, because total removal of methane in reactor 104 may require a high temperature that is not suitable for metallurgy and catalyst, the effluent from reactor 104 after removal of hydrogen chloride may be further purified to remove trace amount of methane. In embodiments of the invention, the trace amounts of methane may be removed via a cryogenic recovery process.

In summary, embodiments of the invention involve a method of purifying a mixture that comprise (1) primarily carbon dioxide and (2) other material that may comprise organic chloride. The method controls the amount of organic chloride reacted in the reactor via temperature control and/or the control of organic chloride concentration in the effluent. The temperature control and/or the control of organic chloride concentration in the effluent may be executed by controlling the flow rate of an external hydrocarbon dosed in the mixture. The resulted product stream may contain less than 50 ppbv organic chloride. Thus, the carbon dioxide is purified for further processes and applications.

Although embodiments of the present invention have been described with reference to blocks of FIG. 2, it should be appreciated that operation of the present invention is not limited to the particular blocks and/or the particular order of the blocks illustrated in FIG. 2. Accordingly, embodiments of the invention may provide functionality as described herein using various blocks in a sequence different than that of FIG. 2.

Although embodiments of the present application and their advantages have been described in detail, it should be understood that various changes, substitutions and alterations can be made herein without departing from the spirit and scope of the embodiments as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the above disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

1. A method of purifying a mixture that comprises (1) primarily carbon dioxide (CO₂) and (2) other material, wherein the other material includes an organic chloride, the method comprising:
flowing the mixture to a reactor;
flowing oxygen (O₂) to the reactor;
reacting at least some of the organic chloride with the O₂ to form additional CO₂;
flowing an effluent from the reactor;
controlling the amount of the organic chloride reacted in the reactor by maintaining reaction temperature in the reactor within a predetermined range, the controlling comprising:
measuring the effluent's temperature; and
if the measured temperature of the effluent is below a predetermined minimum temperature, injecting, or increasing a rate of injecting, an external hydrocarbon into the mixture.

2. The method of claim 1, wherein the controlling further comprises:
if the measured temperature of the effluent is above a predetermined maximum temperature, automatically activating a control valve to stop flow of, or reduce flow of, the external hydrocarbon into the mixture.

3. The method of claim 1, wherein the mixture is from an ethylene glycol plant.

4. The method of claim 1, wherein the other material further include compounds selected from the group consisting of methane, ethylene, ethylene oxide, and combinations thereof.

5. The method of claim 1, wherein the organic chloride is selected from the group consisting of ethylene dichloride, ethylene chloride, vinyl chloride, methyl chloride, acetyl chloride, and combinations thereof.

6. The method of claim 1, wherein the external hydrocarbon comprises fuel gas, the fuel gas is selected from the group consisting of ethylene, methane, ethane, and combinations thereof.

7. The method of claim 1, wherein the flowing the mixture to a reactor comprises:
flowing the mixture to a feed compressor to form a feed stream;
flowing the feed stream from the feed compressor through one or more heat exchangers to heat the feed stream; and
flowing the heated feed stream to the reactor.

8. The method of claim 7, wherein the feed compressor is a two-stage compressor.

9. The method of claim 7, wherein the flowing the oxygen to the reactor comprises:
flowing the oxygen to the feed compressor such that the oxygen mixes with the feed stream;
flowing the oxygen mixed with the feed stream through one or more heat exchangers to heat the oxygen and the feed stream; and
flowing the heated oxygen and the heated feed stream to the reactor.

10. The method of claim 9, wherein the oxygen is flowed to the compressor on a second stage of the compressor.

11. The method of claim 9, wherein the oxygen and the feed stream are heated by the one or more heat exchangers to a temperature in a range of 280° C. to 420° C.

12. The method of claim 1, wherein the reacting is performed in the reactor at an operating pressure of 15 to 20 barg.

13. The method of claim 1, wherein the reacting is performed in the presence of a catalyst selected from the group consisting of Pd, Al₂O₃, and combinations thereof.

14. The method of claim 1, wherein the effluent comprises compounds selected from the group consisting of carbon dioxide, water, inorganic chloride, methane, ethylene, oxygen, nitrogen, argon, ethylene oxide, and combinations thereof.

15. The method of claim 1, further comprising measuring an amount of organic chloride in the effluent.

16. The method of claim 1, wherein an organic chloride content in the effluent is below 5 ppmv.

17. The method of claim 1, wherein the predetermined minimum reaction temperature in the controlling step is 280° C. and the predetermined maximum reaction temperature in the controlling step is 420° C.

18. The method of claim 1, wherein a maximum amount of external hydrocarbon injected in the mixture is 2000 ppmv.

19. A method of purifying a mixture from an ethylene glycol plant that comprises (CO₂) and (2) other material, wherein the other material includes an organic chloride, the method comprising:
flowing the mixture to a reactor;
flowing oxygen (O₂) to the reactor;
reacting at least some of the organic chloride with the O₂ to form additional CO₂;
flowing an effluent from the reactor;
automatically controlling the amount of the organic chloride reacted in the reactor by maintaining reaction temperature in the reactor within a predetermined range, the controlling comprising:
automatically injecting an external hydrocarbon comprising methane, ethylene and other fuel gas into the mixture, wherein the automatically injecting comprises:
automatically measuring the effluent's temperature;
if the measured temperature of the effluent is below a predetermined minimum temperature, automatically activating a control valve to allow flow of, or increase a rate of flow of, the external hydrocarbon into the mixture; and
if the measured temperature of the effluent is above a predetermined maximum temperature, automatically activating the control valve to stop flow of, or reduce flow of, the external hydrocarbon into the mixture.

20. The method of claim 2, wherein the predetermined minimum reaction temperature in the controlling step is 280° C. and the predetermined maximum reaction temperature in the controlling step is 420° C.
